(19) United States
(12) Patent Application Publication
(10) Pub. No.: US 2021/0142292 A1
(43) Pub. Date: May 13, 2021

(54) DETECTING ANOMALOUS CANDIDATE RECOMMENDATIONS

(71) Applicant: Microsoft Technology Licensing, LLC, Redmond, WA (US)

(72) Inventors: Cagri Ozcaglar, Sunnyvale, CA (US); Krishnaram Kenthapadi, Sunnyvale, CA (US)

(73) Assignee: Microsoft Technology Licensing, LLC, Redmond, WA (US)

(21) Appl. No.: 16/682,160

(22) Filed: Nov. 13, 2019

(51) Int. Cl. G06Q 10/10; G06K 9/62; G06N 5/04

(52) U.S. Cl. CPC G06Q 10/1053; G06K 9/6284; G06K 9/623; G06N 5/04; G06K 9/6221

(57) ABSTRACT

The disclosed embodiments provide a system for processing data. During operation, the system estimates parameters of a first distribution of one or more attributes in a first set of candidates selected as recommendations for a recruiting entity in an online system. Next, the system determines a first probability that a candidate belongs to the first distribution based on the estimated parameters and values of the one or more attributes for the candidate. The system then applies a first threshold to the first probability to determine a first classification of the candidate as anomalous or non-anomalous with respect to the first set of candidates. Finally, the system updates a user interface of the online system that outputs the recommendations to the recruiting entity based on the first classification.

### BACKGROUND

### Field

The disclosed embodiments relate to user recommendations. More specifically, the disclosed embodiments relate to techniques for detecting anomalous candidate recommendations.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for ranking candidate search results. For example, the rankings include rankings of candidates for jobs, positions, roles, and/or other opportunities. The rankings also, or instead, include rankings or recommendations of connections, follows, mentorships, referrals, online dating matches, and/or other types of relationships or interactions for members of an online network. Each ranking can be produced by ordering the candidates by descending score from one or more machine learning models. As a result, candidates at or near the top of a ranking may be deemed to be better qualified for the corresponding opportunity and/or recommendation than candidates that are lower in the ranking.

More specifically, the disclosed embodiments include functionality to detect anomalies and/or outliers in candidates that appear in search results and/or recommendations. In some embodiments, a candidate is an anomaly and/or outlier if the candidate has values of attributes that deviate from the distribution of the attributes in a set of candidates outputted in a corresponding set of search results and/or recommendations. For example, a candidate in a set of search results outputted to a recruiting entity (e.g., recruiter, recruiting contract, job poster, hiring manager, etc.) is determined to be anomalous if the candidate's title, skills, seniority, and/or other attributes deviate from the distribution of the attributes in the search results by more than a threshold amount.

To detect anomalies in a set of candidates outputted to a recruiting entity, parameters of the distribution of attributes in the set of candidates are estimated based on vector representations of the attributes for the candidates. For example, a maximum likelihood estimation (MLE) technique is used to estimate a mean vector and covariance matrix for a multivariate normal distribution of the attributes, given the vector representations and a likelihood function for the distribution. Next, the probability that a given candidate belongs to the distribution is calculated based on the estimated parameters and values of the attributes for the candidate. Continuing with the above example, the probability is calculated as the proportional “deviation” of the candidate's attributes from the distribution, given the mean vector and covariance matrix.

The candidate is then classified as anomalous or non-anomalous with respect to the set of candidates based on a comparison of the probability with a threshold. For example, the threshold is set to a value representing a proportion of values that lie outside a certain number of standard deviations from the mean of the distribution. If the probability falls below the threshold, the candidate is determined to be anomalous. If the probability meets or exceeds the threshold, the candidate is determined to be non-anomalous.

Finally, classifications of candidates as anomalous or non-anomalous are used to perform tasks and/or generate output that is displayed and/or delivered via the online system. For example, candidates that are identified to be anomalous are filtered from a ranking of candidates that match a recruiter's search parameters before the ranking is outputted as search results to the recruiter.

By comparing key attributes of individual candidates with distributions of the attributes in sets of candidates that are recommended to recruiting entities, the disclosed embodiments allow candidates with attributes that statistically deviate from the distributions to be identified as anomalous recommendations. Subsequent filtering and/or reordering of the anomalous recommendations in search results and/or other output to the recruiting entities improves the quality or relevance of the search results to the recruiting entities. In turn, the entities are able to identify qualified candidates more quickly, which reduces the amount of searching for and/or viewing of candidates performed by the recruiters. The reduction in processing involved in the recruiters' searches and/or views additionally improves the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to generating recommendations, employment, recruiting, and/or hiring.

### Detecting Anomalous Candidate Recommendations

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) optionally adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

In one or more embodiments, online network 118 includes functionality to improve rankings of candidates 116 outputted as recommendations to recruiters by detecting anomalous recommendations in the rankings. As show in FIG. 2, data 202 from data repository 134 is used to generate rankings 234-236 of candidates in response to parameters 230 of searches by moderators of opportunities. Data 202 includes profile data 216 for members of an online platform (e.g., online network 118 of FIG. 1), as well as user activity data 218 that tracks the members' and/or candidates' activity within and/or outside the platform.

Profile data 216 includes data associated with member profiles in the platform. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the platform.

Attributes of the members are optionally matched to a number of member segments, with each member segment containing a group of members that share one or more common attributes. For example, member segments in the platform may be defined to include members with the same industry, title, location, and/or language.

Connection information in profile data 216 is optionally combined into a graph, with nodes in the graph representing entities (e.g., users, schools, companies, locations, etc.) in the platform. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the platform. For example, user activity data 218 tracks impressions, clicks, likes, dislikes, shares, hides, comments, posts, updates, conversions, and/or other user interaction with content in the platform. User activity data 218 also, or instead, tracks other types of activity, including connections, messages, job applications, job searches, recruiter searches for candidates, interaction between candidates 116 and recruiters, and/or interaction with groups or events. In some embodiments, user activity data 218 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 additionally includes schedules, calendars, and/or upcoming availabilities of the users, which may be used to schedule meetings, interviews, and/or events for the users. Like profile data 216, user activity data 218 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, user activity data 218, and/or other data 202 in data repository 134 is standardized before the data is used by components of the system. For example, skills in profile data 216 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A search apparatus 206 uses data 202 in data repository 134 to identify candidates (e.g., candidates 116 of FIG. 1) that match parameters 230 of a search. For example, search apparatus 206 is provided by a recruiting module or tool that is associated with and/or provided by the platform. Search apparatus 206 includes checkboxes, radio buttons, drop-down menus, text boxes, and/or other user-interface elements that allow a recruiter and/or another moderator involved in hiring for or placing jobs or opportunities to specify parameters 230 related to candidates for an opportunity and/or a number of related opportunities.

Parameters 230 include attributes that are desired or required by the position(s). For example, parameters 230 include thresholds, values, and/or ranges of values for an industry, location, education, skills, past positions, current positions, seniority, overall qualifications, title, seniority, keywords, awards, publications, patents, licenses and certifications, and/or other attributes or fields associated with profile data 216 for the candidates.

In some embodiments, search apparatus 206 matches or converts some or all parameters 230 to standardized attributes in data repository 202. For example, search apparatus 206 converts a misspelled, abbreviated, and/or non-standardized company name, title, location, skill, seniority, and/or other word or phrase in parameters 230 into a standardized identifier or value for a corresponding attribute. Search apparatus 206 also, or instead, adds standardized titles, skills, companies, and/or other attributes that are similar to those specified in parameters 230 to an updated set of parameters 230.

Search apparatus 206 and/or another component then queries data repository 134 for profile data 216 that matches parameters 230. In response to the query, data repository 134 returns member identifiers and/or profile data 216 of candidates that match parameters 230. For example, data repository 134 identifies thousands to tens of thousands of candidates with profile attributes that meet or fit one or more parameters 230.

To improve the quality and/or relevance of search results 232 for a given set of search parameters 230, candidates that meet the criteria represented by parameters 230 are ordered in search results 232 based on features associated with the candidates, parameters 230, and/or the recruiter performing the search. For example, the features include measurements or indicators of each candidate's compatibility with parameters 230; the candidate's level of interest in job-seeking, amount of job-related activity in the platform, and/or willingness to interact with recruiters; representations of parameters 230 and/or a context of the corresponding search; and/or the recruiter's activity, behavior, or preferences on the platform.

A scoring apparatus 209 inputs the features into one or more machine learning models 210-212 to generate one or more sets of scores 226-228 for the candidates. Each set of scores 226-228 is then used to produce a corresponding ranking (e.g., rankings 234-236) of the candidates, and one or more rankings are used to populate search results 232 that are returned in response to a set of search parameters 230.

For example, machine learning models 210-212 include decision trees, random forests, gradient boosted trees, regression models, neural networks, deep learning models, ensemble models, and/or other types of models that generate multiple rounds of scores 226-228 and/or rankings 234-236 for the candidates according to different sets of criteria and/or thresholds. Each score generated by a given machine learning model represents the likelihood of a positive outcome between the candidate and recruiter (e.g., the candidate accepting a message from the recruiter, given an impression of the candidate by the recruiter in search results 232; the recruiter responding to the candidate's job application; placing or advancing the candidate in a hiring pipeline for the job; scheduling of an interview of the candidate for the job; hiring of the candidate for the job; etc.). Thus, an improvement in the performance and/or precision of each machine learning model results in a corresponding increase in the rate of positive outcomes after the candidates are viewed by recruiters in search results 232.

In one or more embodiments, scoring apparatus 208 uses one or more machine learning models 210 to generate a first set of scores 226 from features for all candidates that match parameters 230 (e.g., all candidates returned by data repository 134 in response to a query containing parameters 230). Scoring apparatus 208 also generates ranking 234 by ordering the candidates by descending score from the first set of scores 226.

Next, scoring apparatus 208 obtains a highest-ranked subset of candidates from ranking 234 (e.g., the top 1,000 candidates in ranking 234) and input additional features for the highest-ranked subset of candidates into one or more additional machine learning models 212. Scoring apparatus 208 obtains a second set of scores 228 from machine learning models 212 and generates ranking 236 by ordering the subset of candidates by descending score from the second set of scores 228. As a result, machine learning models 210 may perform a first round of scoring and ranking 234 and/or filtering of the candidates using a first of criteria, and machine learning models 212 may perform a second round of scoring and ranking 234 of a smaller number of candidates using a second set of criteria. The number of candidates scored by machine learning models 212 may be selected to accommodate performance and/or scalability constraints associated with generating results 232 in response to searches received through search apparatus 206.

Search apparatus 206 then uses scores 226-228 and/or rankings 234-236 from scoring apparatus 208 to generate search results 232 that are displayed and/or outputted in response to the corresponding search parameters 230. For example, search apparatus 206 may paginate some or all candidates in ranking 236 into subsets of search results 232 that are displayed as the recruiter scrolls through the search results 232 and/or navigates across screens or pages containing the search results 232.

Search apparatus 206 and/or another component additionally include functionality to output multiple sets of search results 232 based on different rankings 234-236 of candidates by scores 226-228. For example, search apparatus 206 may output, in response to parameters 230 of a search by a recruiter, a first set of search results 232 that includes a “default” ranking of candidates by scores 226 or 228. Search apparatus 206 may also provide one or more user-interface elements that allow the recruiter to filter candidates in the search results by years of work experience, seniority, location, title, function, industry, level of activity on the platform, and/or other criteria. As a result, the system of FIG. 2 may allow the recruiter to manipulate and/or reorder results 232, depending on the recruiter's preferences and/or objectives with respect to a given opportunity or set of opportunities.

As mentioned above, the system of FIG. 2 includes functionality to detect anomalies in results 232 of searches for candidates performed by recruiters. More specifically, an anomaly-detection apparatus 204 estimates parameters 224 of a distribution 214 of attributes in profile data 216 for a set of candidates in results 232 of a given search. The set of candidates includes, but is not limited to, all candidates in results 232 of a given search and/or a subset of highest-ranked candidates in results 232 (e.g., candidates that appear in the first several pages of results 232 shown to the recruiter).

In some embodiments, parameters 224 are estimated based on candidate set attribute vectors 220 containing values of the attributes for the set of candidates and a likelihood function 222 for distribution 214. Candidate set attribute vectors 220 include vector representations of the attributes for individual candidates in the set. For example, each attribute vector in candidate set attribute vectors 220 includes elements representing various standardized skills, titles, seniorities, and/or other attributes in profile data 216. An element representing a standardized title has a value of either 1 or 0, with 1 indicating that the title is found in profile data 216 for the corresponding candidate (e.g., as a current title or past title of the candidate). An element representing a standardized skill has a value between 0 and 1 representing a likelihood of or confidence in the candidate possessing the skill. An element representing a standardized seniority includes a positive integer representing the candidate's current seniority level, with a higher value indicating a higher seniority level.

In one or more embodiments, anomaly-detection apparatus 204 estimates parameters 224 as the mean and variance of a multivariate normal distribution 214 of attribute values in candidate set attribute vectors 220. Such a multivariate normal distribution 214 is assumed based on the central limit theorem and a sufficiently large number of candidates (e.g., at least 30) in the set.

For example, a given recruiter r is associated with a set of n candidates Cᵣ={cᵣ¹, cᵣ², . . . , cᵣⁿ} returned in response to a search by the recruiter and/or selected as recommendations to the recruiter. Each candidate in the set is represented by an attribute vector defined over a set of attributes A, where A includes all possible skills, titles, and seniorities that can be possessed by the candidates. A multivariate normal distribution 214 of the candidates' attribute vectors includes the following representation:

Xᵣ˜N(μᵣ, Σᵣ)
In the above representation, Xᵣ is a random variable representing the set of candidates, which is distributed normally with a mean vector μᵣ and a covariance matrix Σᵣ.

Continuing with the above example, the random variable is associated with the following probability distribution function (e.g., probability density function):

P(xⁱᵣ|μᵣ, Σᵣ)=exp(−½ (xⁱᵣ−μᵣ)^{T} Σᵣ⁻¹(xⁱᵣ−μᵣ))/sqrt((2π)ⁿ·|Σᵣ|)
where |Σᵣ| is the determinant of the covariance matrix, Σᵣ⁻¹ is the inverse of the covariance matrix, and xⁱᵣ is a real column vector of the same dimensionality as the attribute vector.

A log likelihood function 222 for Xᵣ includes the following representation:

$$ln ( L ) = - \frac{n}{2} \vert {\sum }_{r} \vert - \frac{1}{2} {\sum }_{i = 1}^{n} {( {x}_{r}^{i} - {μ}_{r} )}^{T} {\sum }_{r}^{- 1} ( {x}_{r}^{i} - {μ}_{r} ) + constant$$

Taking the derivative of ln(L) with respect to μᵣ and Σᵣ⁻¹ results in the following maximum likelihood mean vector and covariance matrix:

$${\hat{μ}}_{r} = \frac{1}{n} {\sum }_{i = 1}^{n} {x}_{r}^{i}$$

$${\hat{\sum }}_{r} = \frac{1}{n} {\sum }_{i = 1}^{n} ( {x}_{r}^{i} - {\hat{μ}}_{r} ) \cdot {( {x}_{r}^{i} - {\hat{μ}}_{r} )}^{T}$$

Next, anomaly-detection apparatus 204 determines a probability 228 that a given candidate in the set belongs to distribution 214 based on the estimated parameters 224 and candidate attribute values 226 for the candidate. Continuing with the above example, a candidate c with a corresponding attribute vector of candidate attribute values 226 has probability 228 of belonging to the multivariate normal distribution 214 with parameters 224 estimated using \hat{μ}ᵣ and \hat{Σ}ᵣ using the probability distribution function for Xᵣ:

P(c|μᵣ, Σᵣ)=exp(−½ (c−μᵣ)^{T} Σᵣ⁻¹(c−μᵣ))/sqrt((2π)ⁿ|Σᵣ|)

Anomaly-detection apparatus 204 then applies a threshold 238 to probability 228 to generate a classification 240 of the candidate as an anomalous or non-anomalous recommendation within the corresponding set of candidates. Continuing with the above example, threshold 238 is set to a value of 0.003, which represents the proportion of values in distribution 214 that are three or more standard deviations away from the mean. When probability 228 meets or exceeds the threshold, the candidate is determined to be a non-anomalous recommendation (i.e., because candidate attribute values 226 are within three standard deviations from the mean). When probability 228 falls below the threshold, the candidate is determined to be an anomalous recommendation (i.e., because candidate attribute values 226 are more than three standard deviations from the mean). In general, threshold 238 can be selected or tuned to identify a higher or lower proportion of candidates in the set as anomalous.

Finally, anomaly-detection apparatus 204, search apparatus 206, and/or another component of the system update search results 232 based on the value of classification 240 for individual candidates in search results 232. For example, the component applies one or more filters 242 that remove candidates classified as anomalous recommendations from results 232 prior to outputting results 232 to the recruiter performing the search. In another example, the component re-ranks search results 232 so that candidates classified as anomalous recommendations are ranked lower in search results 232 than candidates that are not classified as anomalous recommendations.

In one or more embodiments, anomaly-detection apparatus 204 includes functionality to characterize a given candidate as anomalous or non-anomalous with respect to multiple sets of candidates. For example, anomaly-detection apparatus 204 identifies the candidate in multiple sets of candidates returned as results 232 in response to a series of searches by the same recruiter within a given session and/or multiple searches associated with the same recruiting contract. For each set of candidates, anomaly-detection apparatus 204 estimates parameters 224 of distribution 214 based on candidate set attribute vectors 220 for the set of candidates and likelihood function 222. Anomaly-detection apparatus 204 then uses candidate attribute values 226 for the candidate and parameters 224 to estimate probability 228 that candidate attribute values 226 belong to distribution 214. Anomaly-detection apparatus 204 subsequently uses threshold 238 and probability 228 to generate classification 240 of the candidate as an anomalous or non-anomalous recommendation with respect to the set of candidates.

When multiple values of probability 228 are calculated for the same candidate and multiple sets of results 232 associated with a given query, recruiter, recruiting contract, and/or user session, anomaly-detection apparatus 204 optionally combines the values of probability 228 with a set of weights into an overall “anomaly score” for the candidate. For example, anomaly-detection apparatus 204 calculates the anomaly score as a linear combination of the values of probability 228 and/or a weighted geometric mean of the values of probability 228. Values of probability 228 included in the calculation of the anomaly score are optionally selected to span a sliding window (e.g., a certain number of searches, sessions, days, etc.). In some embodiments, weights used to calculate the anomaly score are learned based on positive or negative outcomes between candidates and the corresponding recruiting entities (e.g., recruiters, recruiting contracts, etc.). In turn, the anomaly score is used in lieu of or in combination with the candidate's probability 228 or classification 228 associated with a given set of results 232 to select the candidate's ranking in results 232 and/or omit the candidate from results 232.

By comparing key attributes of individual candidates with distributions of the attributes in sets of candidates that are recommended to recruiting entities, the system of FIG. 2 allows candidates with attributes that statistically deviate from the distributions to be identified as anomalous recommendations. Subsequent filtering and/or reordering of the anomalous recommendations in search results 232 and/or other output to the recruiting entities improves the quality or relevance of results 232 to the recruiting entities. In turn, the entities are able to identify qualified candidates more quickly, which reduces the amount of searching for and/or viewing of candidates performed by the recruiters. The reduction in processing involved in the recruiters' searches and/or views additionally improves the utilization of processor, memory, storage, input/output (I/O), and/or other resources by the online system and/or the performance of applications, services, tools, and/or computer systems used to implement the platform. Consequently, the disclosed embodiments may improve computer systems, applications, user experiences, tools, and/or technologies related to generating recommendations, employment, recruiting, and/or hiring.

Those skilled in the art will appreciate that the system of FIG. 2 may be implemented in a variety of ways. First, anomaly-detection apparatus 204, scoring apparatus 208, search apparatus 206, and/or data repository 134 may be provided by a single physical machine, multiple computer systems, one or more virtual machines, a grid, one or more databases, one or more filesystems, and/or a cloud computing system. Anomaly-detection apparatus 204, scoring apparatus 208, and search apparatus 206 may additionally be implemented together and/or separately by one or more hardware and/or software components and/or layers.

Second, a number of machine learning models and/or techniques may be used to generate scores 226-228 and/or rankings 234-236. For example, the functionality of each machine learning model may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features used to train the machine learning model. Multiple versions of a machine learning model may further be adapted to different subsets of candidates, recruiters, and/or search parameters 230 (e.g., different member segments), or the same machine learning model may be used to generate one or more sets of scores (e.g., scores 226-228) for all candidates and/or recruiters in the platform. Similarly, the functionality of machine learning models 210-212 may be merged into a single machine learning model that performs a single round of scoring and ranking of the candidates and/or separated out into more than two machine learning models that perform multiple rounds of scoring, filtering, and/or ranking of the candidates.

Similarly, various techniques can be used to determine results 232, parameters 224, probability 228, and/or classification 240. For example, parameters 224 of distribution 214 may be estimated using non-linear least squares, probability plots, Bayesian parameter estimation, and/or other techniques. In another example, anomaly-detection apparatus 204 includes functionality to estimate parameters 224 of various types of distributions and/or determine probabilities that individual sets of attribute values belong to the distributions based on the parameters and attribute values.

Third, the system of FIG. 2 may be adapted to generate and/or update search results 232 or recommendations for various types of searches and/or entities. For example, the functionality of the system may be used to improve and/or personalize search results 232 or recommendations containing candidates for academic positions, artistic or musical roles, school admissions, fellowships, scholarships, competitions, club or group memberships, matchmaking, and/or other types of opportunities.

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, parameters of a distribution of one or more attributes in a set of candidates selected as recommendations for a recruiting entity in an online system are estimated (operation 302). For example, the recruiting entity includes a recruiter, recruiting contract, and/or another type of user or account associated with the online system. The candidates include some or all candidates with attributes that match parameters of a search and/or qualifications or requirements for one or more jobs, positions, or opportunities listed by the recruiting entity. The attributes include, but are not limited to, skills, titles, seniorities, years of experience, industries, locations, and/or other demographic or professional attributes of the candidates.

In one or more embodiments, the parameters include a mean vector and covariance matrix for a multivariate normal distribution of the attributes. The mean vector and covariance matrix are estimated based on a likelihood function for the multivariate normal distribution and vector representations of the candidates' attributes. For example, values of the mean vector and covariance matrix are selected to maximize the log likelihood of the multivariate normal distribution, given attribute vectors storing the candidates' attributes. Each attribute vector includes one or more elements storing binary values indicating the presence or absence of corresponding values of a first attribute (e.g., a title) in a corresponding candidate, one or more elements storing likelihoods of values of a second attribute (e.g., a skill) in the candidate, and/or one or more elements storing a level associated with a third attribute (e.g., a seniority) in the candidate.

Next, a probability that each candidate belongs to the distribution based on the estimated parameters and values of the attribute(s) for the candidate is determined (operation 304). For example, the probability is calculated by inputting the values of the attribute(s) for the candidate into a probability distribution function (e.g., probability density function) for the distribution. The probability distribution function includes a determinant of the covariance matrix, an inverse of the covariance matrix, and/or a difference between the values of the one or more attributes and the mean vector. In particular, the probability distribution function for a multivariate normal distribution includes a numerator that applies an exponential function to the transpose of a vector storing the difference between the attribute value(s) for the candidate and the mean vector, the inverse of the covariance matrix, and the vector. The probability distribution function also includes a denominator that includes the square root of the product of a coefficient with the determinant of the covariance matrix.

A threshold is applied to the probability to determine a classification of the candidate as anomalous or non-anomalous with respect to the set of candidates (operation 306). For example, the threshold represents a proportion of values in the distribution that are a certain number of standard deviations from the mean. If the probability meets or exceeds the threshold, the candidate is classified as non-anomalous. If the probability falls below the threshold, the candidate is classified as an anomaly or outlier in the distribution.

Operations 302-306 are optionally repeated for additional sets of candidates (operation 308) associated with the same recruiting entity. For example, individual candidates are classified as anomalies or non-anomalies with respect to different sets of candidates selected as recommendations in response to multiple queries and/or user sessions for a given recruiter. In another example, the candidates are classified as anomalies or non-anomalies with respect to different sets of candidates selected as recommendations in response to searches and/or other activity by one or more recruiters associated with a recruiting contract.

One or more probabilities associated with each candidate are optionally combined into an anomaly score for the candidate (operation 312). For example, one or more probabilities of a candidate belonging to distributions of attributes in one or more sets of candidates in which the candidate appears are obtained over a sliding window (e.g., a certain number of queries, sessions, days, etc.). The anomaly score is then calculated as a linear combination and/or weighted geometric mean of the probabilities.

Finally, a user interface of the online system that outputs the recommendations to the recruiting entity is updated based on the probabilities, classifications, and/or anomaly scores (operation 314). For example, a candidate is omitted from recommendations outputted to a recruiting entity in the user interface when the candidate is classified as anomalous with respect to the set of candidates in the recommendations and/or the candidate's anomaly score for a series of searches and/or sessions involving the recruiting entity exceeds a threshold. In another example, the candidate's position in a ranking of recommendations outputted to the recruiting entity is selected and/or determined based on the candidate's probability of belonging to the distribution of attributes in the recommendations, the candidate's classification as anomalous or non-anomalous, the candidate's anomaly score, and/or other factors.

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes an anomaly-detection apparatus and a search apparatus, one or more of which may alternatively be termed or implemented as a module, mechanism, or other type of system component. The anomaly-detection apparatus estimates parameters of a distribution of one or more attributes in a set of candidates selected as recommendations for a recruiting entity in an online system. Next, the anomaly-detection apparatus determines a probability that a candidate belongs to the distribution based on the estimated parameters and values of the attribute(s) for the candidate. The anomaly-detection apparatus then applies a threshold to the probability to determine a classification of the candidate as anomalous or non-anomalous with respect to the set of candidates. Finally, the search apparatus updates a user interface of the online system that outputs the recommendations to the recruiting entity based on the first classification.

In addition, one or more components of computer system 400 may be remotely located and connected to the other components over a network. Portions of the present embodiments (e.g., anomaly-detection apparatus, scoring apparatus, search apparatus, data repository, online network, etc.) may also be located on different nodes of a distributed system that implements the embodiments. For example, the present embodiments may be implemented using a cloud computing system that generates candidate search results for searches performed by a set of remote recruiting entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
estimating, by one or more computer systems, parameters of a first distribution of one or more attributes in a first set of candidates selected as recommendations for a recruiting entity in an online system;
determining, by the one or more computer systems, a first probability that a candidate belongs to the first distribution based on the estimated parameters and values of the one or more attributes for the candidate;
applying, by the one or more computer systems, a first threshold to the first probability to determine a first classification of the candidate as anomalous or non-anomalous with respect to the first set of candidates; and
updating, by the one or more computer systems, a user interface of the online system that outputs the recommendations to the recruiting entity based on the first classification.

2. The method of claim 1, further comprising:
estimating additional parameters of a second distribution of the one or more attributes in a second set of candidates selected as additional recommendations for the recruiting entity;
determining a second probability that the candidate belongs to the second distribution based on the estimated additional parameters and the values of the one or more attributes for the candidate;
applying a second threshold to the second probability to determine a second classification of the candidate as anomalous or non-anomalous with respect to the second set of candidates; and
combining the first and second probabilities into an anomaly score for the candidate.

3. The method of claim 2, wherein combining the first and second probabilities into the anomaly score for the candidate comprises at least one of:
calculating the anomaly score as a linear combination of the first and second probabilities; and
calculating the anomaly score as a weighted geometric mean of the first and second probabilities.

4. The method of claim 2, wherein the first and second sets of candidates are selected based on at least one of:
one or more searches by the recruiting entity;
one or more sessions by the recruiting entity with the online system;
a recruiter representing the recruiting entity; and
a recruiting contract representing the recruiting entity.

5. The method of claim 1, wherein estimating the parameters of the first distribution comprises:
obtaining vector representations of the one or more attributes for the first set of candidates; and
estimating a mean vector and a covariance matrix for the first distribution based on the vector representations and a likelihood function for the first distribution.

6. The method of claim 5, wherein determining the first probability that the candidate belongs to the first distribution based on the estimated parameters and the values of the one or more attributes for the candidate comprises:
calculating the probability based on a determinant of the covariance matrix and a difference between the values of the one or more attributes and the mean vector.

7. The method of claim 5, wherein the vector representations comprise:
a binary value indicating a presence or an absence of a first attribute in another candidate;
a likelihood of a second attribute in the other candidate; and
a level associated with a third attribute in the other candidate.

8. The method of claim 1, wherein applying the first threshold to the first probability to determine the first classification of the candidate as anomalous or non-anomalous with respect to the first set of candidates comprises:
classifying the candidate as anomalous with respect to the first set of candidates when the first probability falls below the first threshold.

9. The method of claim 1, wherein updating the user interface of the online system that outputs the recommendations to the recruiting entity based on the classification comprises at least one of:
omitting the candidate from the recommendations outputted to the recruiting entity in the user interface when the classification indicates that the candidate is anomalous with respect to the first set of candidates; and
selecting a position of the candidate in a ranking of the recommendations outputted to the recruiting entity based on the classification.

10. The method of claim 1, wherein the one or more attributes comprise at least one of:
a skill;
a title;
a seniority; and
a location.

11. The method of claim 1, wherein the first set of candidates comprises at least one of:
a set of search results for a search by the recruiting entity; and
one or more pages of the search results.

12. A system, comprising:
one or more processors; and
memory storing instructions that, when executed by the one or more processors, cause the system to:
estimate parameters of a first distribution of one or more attributes in a first set of candidates selected as recommendations for a recruiting entity in an online system;
determine a first probability that a candidate belongs to the first distribution based on the estimated parameters and values of the one or more attributes for the candidate;
apply a first threshold to the first probability to determine a first classification of the candidate as anomalous or non-anomalous with respect to the first set of candidates; and
update a user interface of the online system that outputs the recommendations to the recruiting entity based on the first classification.

13. The system of claim 12, wherein the memory further stores instructions that, when executed by the one or more processors, cause the system to:
estimate additional parameters of a second distribution of the one or more attributes in a second set of candidates selected as additional recommendations for the recruiting entity;
determine a second probability that the candidate belongs to the second distribution based on the estimated additional parameters and the values of the one or more attributes for the candidate;
apply a second threshold to the second probability to determine a second classification of the candidate as anomalous or non-anomalous with respect to the second set of candidates; and
combine the first and second probabilities into an anomaly score for the candidate.

14. The system of claim 13, wherein the first and second sets of candidates are selected based on at least one of:
one or more searches by the recruiting entity;
one or more sessions by the recruiting entity with the online system;
a recruiter representing the recruiting entity; and
a recruiting contract representing the recruiting entity.

15. The system of claim 12, wherein estimating the parameters of the first distribution comprises:
obtaining vector representations of the one or more attributes for the first set of candidates; and
estimating a mean vector and a covariance matrix in a way that maximizes a log likelihood for the first distribution, given the vector representations.

16. The system of claim 15, wherein determining the first probability that the candidate belongs to the first distribution based on the estimated parameters and the values of the one or more attributes for the candidate comprises:
calculating the probability based on a determinant of the covariance matrix, an inverse of the covariance matrix, and a difference between the values of the one or more attributes and the mean vector.

17. The system of claim 15, wherein the vector representations comprise:
a binary value indicating a presence or an absence of a title in another candidate;
a likelihood of a skill in the other candidate; and
a level associated with a seniority of the other candidate.

18. The system of claim 12, wherein the first set of candidates comprises at least one of:
a set of search results for a search by the recruiting entity; and
one or more pages of the search results.

19. A non-transitory computer-readable storage medium storing instructions that when executed by a computer cause the computer to perform a method, the method comprising:
estimating parameters of a first distribution of one or more attributes in a first set of candidates selected as recommendations for a recruiting entity in an online system;
determining a first probability that a candidate belongs to the first distribution based on the estimated parameters and values of the one or more attributes for the candidate;
applying a first threshold to the first probability to determine a first classification of the candidate as anomalous or non-anomalous with respect to the first set of candidates; and
updating a user interface of the online system that outputs the recommendations to the recruiting entity based on the first classification.

20. The non-transitory computer-readable storage medium of claim 19, the method further comprising:
estimating additional parameters of a second distribution of the one or more attributes in a second set of candidates selected as additional recommendations for the recruiting entity;
determining a second probability that the candidate belongs to the second distribution based on the estimated additional parameters and the values of the one or more attributes for the candidate;
applying a second threshold to the second probability to determine a second classification of the candidate as anomalous or non-anomalous with respect to the second set of candidates; and
combining the first and second probabilities into an anomaly score for the candidate.
